(19) United States
(12) Patent Application Publication
(10) Pub. No.: US 2022/0046919 A1
(43) Pub. Date: Feb. 17, 2022

(54) SYNERGISTIC INSECTICIDAL COMBINATIONS

(71) Applicant: UPL LTD, Haldia (IN)

(72) Inventors: Ramprakash Krishna Srivastava, Mumbai (IN); Veera Parasu Uppara, Mumbai (IN); Sanjay Pradnya Lokhande, Mumbai (IN); Gopal Govind Sawant, Mumbai (IN)

(21) Appl. No.: 17/433,687

(22) PCT Filed: Mar. 13, 2020
(86) PCT No.: PCT/IB2020/052261

§ 371 Date: Aug. 25, 2021

(30) Foreign Application Priority Data
Mar. 13, 2019 (IN) 201931009832

(51) Int. Cl. A01N 37/44; A01N 43/88; A01N 43/40; A01P 7/04

(52) U.S. Cl. CPC A01N 37/44; A01P 7/04; A01N 43/40; A01N 43/88

(57) ABSTRACT

The present invention relates to a synergistic insecticidal combination. In particular, the present invention provides an insecticidal combination comprising aversive agent and at least one insecticide which is useful against harmful pests in plants. The present invention also provides method of controlling harmful pests in plants using said composition.

### FIELD OF INVENTION

The present invention relates to a synergistic insecticidal combination. In particular, the present invention provides an insecticidal combination comprising aversive agent and at least one insecticide which is useful against harmful pests in plants. The present invention also provides method of controlling harmful pests in plants using said composition.

### BACKGROUND OF INVENTION

The protection of crops and its produce from insect pest damage is essential in agriculture produce enhancement. Chemical control by the use of various chemicals and formulations is an important tool in agriculture for the prevention and control of pests. Insecticides of many types and groups are reported in the literature and a large number are in use, commercially, for control of pests in agriculture.

Sucking pests have become quite serious from seedling stage, their heavy infestation at times reduces the crop yield to a great extent. The estimated loss due to sucking pests is up to 21.20% (Dhawan et al., 1988). Among the sap feeders leafhoppers commonly known as Jassids is one of the most abundant groups of plant feeding insects in the world.

Jassids (Hemiptera: Cicadellidae) are wedge shaped insects which walk diagonally and suck the cell sap from piercing type of mouth parts. While sucking the cell sap they inject toxins into the plant body which results yellowing and curling of leaves, dropping down of flowering and fruiting bodies. They secrete honey dew like sticky substance which create sooty mould on leaves and affect photosynthesis, growth and finally the yield of the crop. [Reference: Sathe, T. V., Nilam Shendage, and Chandni Kamble. “Biodiversity of Jassids from agroecosystems of Kolhapur district, India.” Int. Nat. J. Sci. Environ. and Tech 3.3 (2014): 1053-1058.]

Conventional insecticides have been recommended for the management of Jassids in plants.

The Insecticide Resistance Action Committee (IRAC) classifies the various insecticides according to their mode of action. [Reference: Sparks, Thomas C., and Ralf Nauen. “IRAC: Mode of action classification and insecticide resistance management.” Pesticide biochemistry and physiology 121 (2015): 122-128.]

N-cyanomethyl-4-trifluoromethyl-3-pyridinecarboxyamide (common name: Flonicamid) is used as an active ingredient for a pesticide for controlling Jassids. Flonicamid is a chordotonal organ modulator in the insecticide resistance action committee (IRAC) group 29.

Nicotinic acetylcholine receptor (nAChR) competitive modulators are another class of insecticides classified in Group 4 by the IRAC group. The principle pest target for such insecticides is the sap-feeding insects. Crossthwaite et. al discloses the nicotinic acetylcholine receptor (nAChR) competitive modulators insecticides alongwith their mode of action. [Reference: Crossthwaite, Andrew J., et al. “The invertebrate pharmacology of insecticides acting at nicotinic acetylcholine receptors.” Journal of Pesticide Science 42.3 (2017): 67-83.]

However, the present insecticides currently in use for controlling Jassids are not that effective; and, due to their prolonged indiscriminate and non-judicious use, Jassids have developed resistance to such commonly used insecticides. The use of insecticides for the prevention and control of Jassids is thereby becoming increasingly difficult. Therefore, there is an urgent need to develop new methods and formulations for controlling these harmful pests. Potent synergistic insecticidal composition would by useful to manage insect pests for a desired higher crop yield and to control those insects which are hard to kill by existing commercial insecticides solely and in cyclic spray mixtures.

The use of Denatonium compounds, in particular, Denatonium Benzoate and Denatonium Saccharide, as aversive agents is known. See U.S. Pat. Nos. 3,080,327, 3,268,577, 4,661,504 and 4,652,577.

Denatonium benzoate, also known as phenylmethyl-[2-[(2,6-dimethylphenyl)amino]-2-oxoethyl]-diethylammonium benzoate, CAS no. 3734-33-6. Formula: C₂₈H₃₄N₂O₃ molecular weight: 446.58 g/mol.

Denatonium benzoate is commercially sold as BITREX®, available from Macfarlan Smith, Edinburgh, Scotland, UK. Bitrex is a quaternary ammonium salt formed by the combination of a cationic quaternary ammonium salt with an inert anion such as benzoate ion or saccharin anion. Having the following structure:

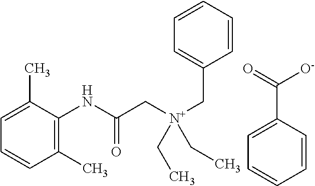 [SMILES: CC[N+](CC)(CC(=O)Nc1c(C)cccc1C)Cc1ccccc1 ; O=C([O-])c1ccccc1]

Denatonium benzoate is listed in the Guinness Book of Records and the Merck Index as “the bitterest substance known to man”. Denatonium benzoate can be detected by the average person at 10 ppb and has a generally recognized bitter taste at 50 ppb (Anon. 1989). The normal application range is 6-50 ppm, depending on the nature of the product to which it is added. Bitrex chemically resembles natural bitter substances such as quinine in having a molecular structure with separately charged elements that act on taste receptors. However, clinical trials have proven that its extremely human safe drug.

Denatonium benzoate is generally used as a bittering agent (or aversive agent) to prevent eating of toxic substances. For example, added to industrial alcohol, paint, toilet cleaners, liquid soaps, and shampoos in order to prevent poisoning in people, animals. Also, For example, it can be used in a dilute solution to brush on the fingernails of people who are compulsive fingernail-biters or on the thumbs of children who suck their thumbs more than they should. Denatonium benzoate is also used as an animal repellent such as cat, dog, and bird repellents, for prevention of cannibalism in pigs, to keep horses from chewing their stalls, deer from nibbling tree shoots, and to keep hedgehogs from eating slug pellets (Payne 1988).

U.S. Pat. No. 6,399,109B1 discloses a liquid insecticide solution comprising a 5% to 20% water solution of a disodium octaborate tetrahydrate (“DOT”) as insecticide, colored pigment, and a bittering agent of either sucrose octa-acetate or Denatonium benzoate, is provided. This solution containing disodium octaborate tetrahydrate insecticide kills fungi that cause wood rot in addition to wood-destroying insects such as, e.g., termites, beetles, and carpenter ants.

WO94/22299A1 discloses solid insecticidal composition comprising a mixture of two insecticidally active ingredients in association with an insect-attractive bait substance characterized in that the first insecticidally active ingredients is an insect growth regulator active against larval stages of an insect and the second insecticidally active ingredient is a direct toxicant having knock down and lethal effects in adult stages of the insect, the insect-attracting bait substance being attractive to both adult and larval stages of the insect, wherein the first insecticidally active ingredient is pyriproxyfen and the second insecticidally active ingredient is a pyrethroid or an organo-phosphorus compound.

Therefore, there is a long felt need to develop novel and effective insecticidal combinations for controlling the harmful pests in plants and demonstrating a high efficacy, high selectivity, environmentally safe and can be advantageously formulated. Till date there is no report of employing aversive agents such as Denatonium benzoate in insecticidal combinations for enhancing the efficacy of the insecticidal formulation to control harmful pest. The present inventors have surprisingly developed an effective insecticidal combination which ameliorates the aforesaid shortcomings of the prior art.

### OBJECTS OF THE INVENTION

It is an object of the present invention to provide a novel and effective insecticidal combination demonstrating a high efficacy and a high selectivity.

It is another object of the present invention to provide a novel and effective insecticidal combination for controlling the harmful pests in plants.

It is another object of the present invention to provide a novel and effective insecticidal combination which can be easily formulated.

It is another object of the present invention to provide a novel and effective insecticidal combination which is environmentally safe.

It is another object of the present invention to provide a method for controlling pests in plants.

### SUMMARY OF THE INVENTION

It is an aspect of the present invention to provide an insecticidal combination comprising an aversive agent.

It is another aspect of the present invention to provide an insecticidal combination comprising:
i) an aversive agent and
ii) at least one insecticide.

It is another aspect of the present invention to provide an insecticidal composition comprising:
i) an aversive agent
ii) at least one insecticide and
iii) agrochemically acceptable excipients.

It is another aspect of the present invention to provide a method for controlling pests in plants, said method comprising applying to the locus of the insect pest infestation, an insecticidal combination comprising an aversive agent and at least one insecticide.

### BRIEF DESCRIPTION OF THE DRAWINGS

The above and other aspects, features and advantages of certain exemplary embodiments of the present invention will be more apparent from the following description taken in conjunction with the accompanying drawings wherein:

FIG. 1: Photographic image of damaged leaf of Okra infected by Jassids

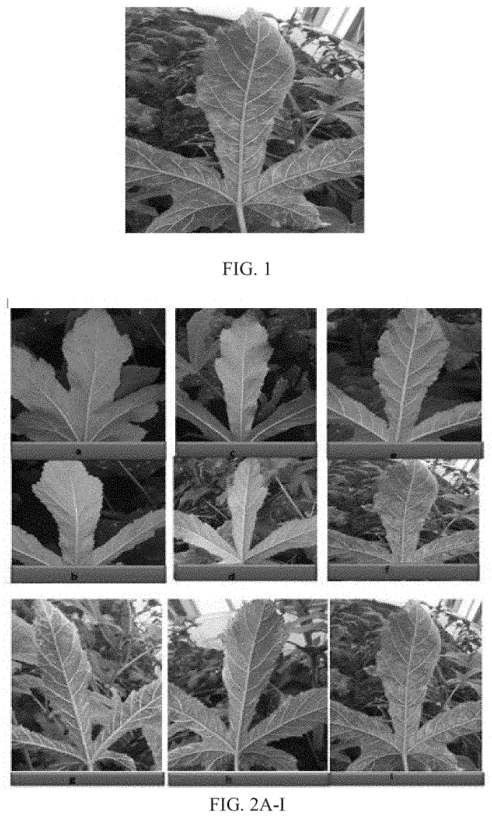

FIG. 2: Photographic images of treatment effects with combinations of the present invention on Okra:
(a) T-1 Denatonium Benzoate+Ulala @ 5+0.4 ml
(b) T-4 Ulala @ 0.4 g/lit water
(c) T-2 Denatonium Benzoate+Thiamethoxam @ 5+0.5 ml
(d) T-5 Thiamethoxam @ 0.4 g
(e) T-3 Denatonium Benzoate+Imidacloprid. @ 5+0.5 ml
(f) T-9 Untreated control
(g) T-7 Denatonium Benzoate @ 4 ml/lit of water
(h) T-8 Denatonium Benzoate @ 5 ml/lit of water
(i) T-9—Untreated Control

### DETAILED DESCRIPTION OF THE INVENTION

The following description with reference to the accompanying drawings is provided to assist in a comprehensive understanding of exemplary embodiments of the invention. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the scope of the invention as defined by the appended claims and their equivalents.

It is to be understood that the singular forms “a,” “an,” and “the” include plural referents unless the context clearly dictates otherwise.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, steps or components but does not preclude the presence or addition of one or more other features, steps, components or groups thereof.

The term ‘plants’ as used herein, refers to all physical parts of a plant, including seeds, seedlings, saplings, roots, tubers, stems, stalks, foliage and fruits.

The term “insects” as used herein, includes all organisms in the class “Insecta.”

The term “Jassids” as used herein refers to sucking pests, leafhoppers from the family Cicadellidae (Jassidae).

The term “Insecticidal” as used herein, refers to the ability of a pesticide to increase mortality or inhibit growth rate of insects.

The term “locus” as used herein, refers to the part to which a combination according to the invention is applied. It includes application to an individual plant, a group of plants such as a plant and/or its surrounding, and the region in which plants may be planted as well application directly to an insect or insects and/or the vicinity in which they are located.

The term “agriculturally acceptable amount of active” refers to an amount of an active that kills or inhibits the plant disease for which control is desired, in an amount not significantly toxic to the plant being treated.

The term “% by weight” (percent by weight) as used herein, unless otherwise defined, relates to the relative weight of the respective component based on the total weight of the formulation.

To “control” or “controlling” insects means to inhibit, through a toxic effect, the ability of insect pests to survive, grow, feed, and/or reproduce, or to limit insect-related damage or loss in crop plants. To “control” insects may or may not mean killing the insects, although it preferably means killing the insects.

The term “aversive agents” as used herein refers to the class of compounds which cause rejection of a material by presenting unpleasant gustatory cues such as flavors, textures, or other taste (and sometimes associative odor) characteristics. There are two primary classes of aversive agents: bitterants, chemicals producing a bitter flavor, and pungent agents, chemicals producing an unpleasantly pungent flavor.

The term “chordotonal organ modulator” as used herein, refers to the class of insecticides classified by the insecticide resistance action committee (IRAC) group 29 which disrupts the chordotonal organs (i.e. stretch receptors) of the insects thereby interfering with movement, hearing and balance, causing the insect to stop feeding.

The term “Nicotinic acetylcholine receptor (nAChR) competitive modulators” as used herein refers to another class of insecticides classified in Group 4 by the IRAC group. The nicotinic acetylcholine receptor (nAChR) is a ligand-gated ion channel composed of 5 protein subunits arranged around a central cation selective pore. Insecticides mediate their effect through interacting at nAChRs.

In an aspect the present invention provides an insecticidal composition comprising aversive agent for controlling the growth of insects.

The present invention relates to a novel and effective insecticidal combination comprising:
i) an aversive agent and
ii) at least one insecticide.

Surprisingly, the inventors of the present inventors have found that addition of an aversive agent to at least one insecticide results in an unexpected enhancement of the efficacy, and a surprising reduction in plant disease incidence and enhanced pest control in comparison to the efficacy seen with the insecticides alone. It has been observed that the aversive agent which is conventionally used as a bitterant and otherwise does not demonstrate any insecticidal effect, unexpectedly enhances the efficacy of insecticides in combination and shows synergy. The efficacy of insecticides is enhanced after addition of an aversive agent. It is found to be more effective in killing Jassids (sucking pests) as compared to using insecticides alone.

In an embodiment, the composition comprises denatonium compounds as aversive agent, the denatonium compound is typically present in the composition at a concentration in the range of about 0.01 to 50% wt/v, preferably 0.01 to 20% w/v, more preferably in the range of about 0.01 to 10% w/v which include 1%, 2%, 3%, 4%, 5%, 6%, 7%, 8% and 9% w/v.

In an embodiment, the aversive agent is used in an amount of about 1 to 5% w/w of total weight of the composition.

In an embodiment, Denatonium compound is selected from the group consisting of denatonium chloride, denatonium citrate, denatonium saccharide, denatonium carbonate, denatonium acetate, denatonium benzoate, denatonium benzoate monohydrate and mixtures thereof.

In an embodiment, the preferred aversive agent is Denatonium benzoate.

In an embodiment, the insecticides are selected from chordotonal organ modulators, nicotinic acetylcholine receptor (nAChR) competitive modulators; Acetylcholinesterase (AChE) inhibitors, GABA-gated chloridechannel blockers, Sodium channel modulators, Nicotinic acetylcholine receptor (nAChR) allosteric modulators—Site I, Glutamate-gated chloride channel (GluCl) allosteric modulators, Juvenile hormone mimics, Miscellaneous nonspecific (multi-site) inhibitors, Chordotonal organ TRPV channel modulators, Mite growth inhibitors affecting CHS1, Microbial disruptors of insect midgut membranes, Inhibitors of mitochondrial ATP synthase, Uncouplers of oxidative phosphorylation via disruption of the proton gradient, Nicotinic acetylcholine receptor (nAChR) channel blockers, Inhibitors of chitin biosynthesis affecting CHS1, Inhibitors of chitin biosynthesis, type 1, Moulting disruptors, Dipteran, Ecdysone receptor agonists, Octopamine receptor agonists, Mitochondrial complex III electron transport inhibitors, Mitochondrial complex I electron transport inhibitors, Voltage-dependent sodium channel blockers, Inhibitors of acetyl CoA carboxylase, Mitochondrial complex IV electron transport inhibitors, Mitochondrial complex II electron transport inhibitors, Ryanodine receptor modulators, GABA-gated chloride channel allosteric modulators and unknown mode of action compounds or combinations thereof.

In an embodiment, the amount of insecticide used in the present invention may be the recommended dose of each insecticide used in the agriculture industry.

In an embodiment, the total amount of the insecticide is used in an amount in the range of 0.1 to 99% by weight, preferably 0.2 to 90% by weight, more preferably 0.5 to 90% by weight.

In an embodiment, the chordotonal organ modulator insecticide is Flonicamid.

In an embodiment, flonicamid used is flonicamid 50% wet granular (WG) and can be used in an amount of 150 to 200 g/ha.

In an embodiment, the nicotinic acetylcholine receptor (nAChR) competitive modulators insecticides are selected from neonicotinoids, nicotine, sulfoximines, butenolides, mesoionics or combinations thereof.

In an embodiment of the present invention, an agrochemical composition comprises neonicotinoid insecticide.

In an embodiment of the present invention, neonicotinoid insecticide is selected from the group comprising of acetamiprid, clothianidin, imidacloprid, nitenpyram, nithiazine, Dinotefuran, thiacloprid, thiamethoxam or combinations thereof.

In an embodiment of the present invention, neonicotinoid insecticide is imidacloprid.

In an embodiment, neonicotinoid insecticide is Imidacloprid 17.8% SL and can be used in an amount of 100 to 125 ml/ha.

In an embodiment the neonicotinoid insecticide is thiamethoxam.

In an embodiment, thiamethoxam used is Thiamethoxam 25% WG and can be used in an amount of 100 g/ha.

In an embodiment, the sulfoximines is Sulfoxaflor.

In an embodiment, the butenolides is Flupyradifurone.

In an embodiment, the mesoionics is Triflumezopyrim.

In an embodiment Acetylcholinesterase (AChE) inhibitors is selected from Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC, Xylylcarb, Acephate, Azamethiphos, Azinphos-ethyl, Azinphosmethyl, Cadusafos, Chlorethoxyfos, Chlorfenvinphos, Chlormephos, Chlorpyrifos, Chlorpyrifos-methyl, Coumaphos, Cyanophos, Demeton-S-methyl, Diazinon, Dichlorvos/DDVP, Dicrotophos, Dimethoate, Dimethylvinphos, Disulfoton, EPN, Ethion, Ethoprophos, Famphur, Fenamiphos, Fenitrothion, Fenthion, Fosthiazate, Heptenophos, Imicyafos, Isofenphos, Isopropyl O-(methoxyaminothio-phosphoryl) salicylate, Isoxathion, Malathion, Mecarbam, Methamidophos, Methidathion, Mevinphos, Monocrotophos, Naled, Omethoate, Oxydemeton-methyl, Parathion, Parathion-methyl, Phenthoate, Phorate, Phosalone, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Trichlorfon, Vamidothion.

In an embodiment GABA-gated chloride channel blockers is selected from Chlordane, Endosulfan, Ethiprole and Fipronil.

In an embodiment Sodium channel modulators is selected from Acrinathrin, Allethrin, d-cis-trans Allethrin, d-trans Allethrin, Bifenthrin, Bioallethrin, Bioallethrin Scyclopentenyl isomer, Bioresmethrin, Cycloprothrin, Cyfluthrin, beta-Cyfluthrin, Cyhalothrin, lambdaCyhalothrin, gamma-Cyhalothrin, Cypermethrin, alpha-Cypermethrin, beta-Cypermethrin, thetacypermethrin, zeta-Cypermethrin, Cyphenothrin, (1R)-trans-isomers], Deltamethrin, Empenthrin (EZ)-(1R)-isomers], Esfenvalerate, Etofenprox, Fenpropathrin, Fenvalerate, Flucythrinate, Flumethrin, tau-Fluvalinate, Halfenprox, Imiprothrin, Kadethrin, Permethrin, Phenothrin [(1R)-trans-isomer], Prallethrin, Pyrethrins (pyrethrum), Resmethrin, Silafluofen, Tefluthrin, Tetramethrin, Tetramethrin [(1R)-isomers], Tralomethrin, Transfluthrin, DDT and Methoxychlor.

In an embodiment, Nicotinic acetylcholine receptor (nAChR) allosteric modulators—Site I is selected from Spinetoram, Spinosad.

In an embodiment, Glutamate-gated chloride channel (GluC 1) allosteric modulators is selected from Abamectin, Emamectin benzoate, Lepimectin, Milbemectin.

In an embodiment, Juvenile hormone mimics is selected from the group comprising Hydroprene, Kinoprene, Methoprene, Fenoxycarb and Pyriproxyfen.

In an embodiment, Miscellaneous nonspecific (multi-site) inhibitors is selected from Methyl bromide and other alkyl halides, Chloropicrin, Cryolite (Sodium aluminum fluoride), Sulfuryl fluoride, Borax, Boric acid, Disodium octaborate, Sodium borate, Sodium metaborate, Tartar emetic, Dazomet and Metam.

In an embodiment, Chordotonal organ TRPV channel modulators is selected from Pymetrozine, Pyrifluquinazon, Afidopyropen.

In an embodiment, Mite growth inhibitors affecting CHS1 is selected from Clofentezine, Diflovidazin, Hexythiazox and Etoxazole.

In an embodiment, Microbial disruptors of insect midgut membranes is selected from Bacillus thuringiensis subsp. israelensis Bacillus thuringiensis subsp. aizawai Bacillus thuringiensis subsp. kurstaki Bacillus thuringiensis subsp. tenebrionis B.t. crop proteins: Cry1Ab, Cry1Ac, Cry1Fa, Cry1A.105, Cry2Ab, Vip3A, mCry3A, Cry3Ab, Cry3Bb, Cry34Ab1/Cry35Ab1 and Bacillus sphaericus.

In an embodiment Inhibitors of mitochondrial ATP synthase is selected from Diafenthiuron, Azocyclotin, Cyhexatin, Fenbutatin oxide, Propargite and Tetradifon. In an embodiment, Uncouplers of oxidative phosphorylation via disruption of the proton gradient is selected from Chlorfenapyr DNOC Sulfluramid.

In an embodiment, Nicotinic acetylcholine receptor (nAChR) channel blockers is selected from Bensultap, Cartap hydrochloride, Thiocyclam, Thiosultap-sodium.

In an embodiment, Inhibitors of chitin biosynthesis affecting CHS1.

In an embodiment Inhibitors of chitin biosynthesis affecting CHS1 is selected from Bistrifluron, Chlorfluazuron, Diflubenzuron, Flucycloxuron, Flufenoxuron, Hexaflumuron, Lufenuron, Novaluron, Noviflumuron, Teflubenzuron and Triflumuron.

In an embodiment, inhibitors of chitin biosynthesis, type 1 is Buprofezin.

In an embodiment, Moulting disruptors, Dipteran is Cyromazine.

In an embodiment, Ecdysone receptor agonists is Chromafenozide, Halofenozide, Methoxyfenozide, Tebufenozide.

In an embodiment, Octopamine receptor agonists is Amitraz.

In an embodiment, Mitochondrial complex III electron transport inhibitors is selected from Hydramethylnon, Acequinocyl, Fluacrypyrim and Bifenazate.

In an embodiment, 21 Mitochondrial complex I electron transport inhibitors is selected from Fenazaquin, Fenpyroximate, Pyridaben, Pyrimidifen, Tebufenpyrad Rotenone (Derris) and Tolfenpyrad.

In an embodiment, Voltage-dependent sodium channel blockers is selected from Indoxacarb, Metaflumizone.

In an embodiment, Inhibitors of acetyl CoA carboxylase is selected from Spirodiclofen, Spiromesifen and Spirotetramat.

In an embodiment, Mitochondrial complex IV electron transport inhibitors is selected from Aluminium phosphide, Calcium phosphide, Phosphine, Zinc phosphide, Calcium cyanide, Potassium cyanide, Sodium cyanide.

In an embodiment, Mitochondrial complex II electron transport inhibitors is selected from Cyenopyrafen, Cyflumetofen and Pyflubumide.

In an embodiment, Ryanodine receptor modulators is selected from Chlorantraniliprole, Cyantraniliprole, Cyclaniliprole and Flubendiamide.

In an embodiment, GABA-gated chloride channel allosteric modulators is selected from Broflanilide and Fluxametamide.

In an embodiment, unknown mode of action compounds are selected from Azadirachtin, Benzoximate, Bromopropylate, Chinomethionat, Dicofol, Lime sulfur, Pyridalyl and Sulfur.

According to present invention the present invention provides an insecticidal combination comprising aversive agent and at least one insecticide.

The present composition comprises denatonium benzoate as aversive agent.

The present composition comprises insecticide selected from the group comprising chordotonal organ modulators, nicotinic acetylcholine receptor (nAChR) competitive modulators; Acetylcholinesterase (AChE) inhibitors, GABA-gated chloridechannel blockers, Sodium channel modulators, Nicotinic acetylcholine receptor (nAChR) allosteric modulators—Site I, Glutamate-gated chloride channel (GluCl) allosteric modulators, Juvenile hormone mimics, Miscellaneous nonspecific (multi-site) inhibitors,

Chordotonal organ TRPV channel modulators, Mite growth inhibitors affecting CHS1, Microbial disruptors of insect midgut membranes, Inhibitors of mitochondrial ATP synthase, Uncouplers of oxidative phosphorylation via disruption of the proton gradient, Nicotinic acetylcholine receptor (nAChR) channel blockers, Inhibitors of chitin biosynthesis affecting CHS1, Inhibitors of chitin biosynthesis, type 1, Moulting disruptors, Dipteran, Ecdysone receptor agonists, Octopamine receptor agonists, Mitochondrial complex III electron transport inhibitors, Mitochondrial complex I electron transport inhibitors, Voltage-dependent sodium channel blockers, Inhibitors of acetyl CoA carboxylase, Mitochondrial complex IV electron transport inhibitors, Mitochondrial complex II electron transport inhibitors, Ryanodine receptor modulators, GABA-gated chloride channel allosteric modulators and unknown mode of action compounds or combinations thereof.

The present composition comprising a combination of aversive agent and at least one insecticide and agrochemically acceptable excipient.

The aversive agent is used in an amount in the range of 0.01 to 50% w/w.

The insecticide is used in an amount in the range of 0.1 to 99% w/w.

The present composition comprises denatonium benzoate as aversive agent and insecticide is selected from chordotonal organ modulator insecticide or neonicotinoid insecticide.

The present composition comprises denatomium benzoate and at least one insecticide selected from flonicamid, imidacloprid or thiamethoxam.

In an embodiment, the insecticidal combination comprises Denatonium benzoate and Flonicamid.

In another embodiment, the insecticidal combination comprises Denatonium benzoate and Thiamethoxam.

In an embodiment, the insecticidal combination comprises Denatonium benzoate and Imidacloprid.

The combinations of the present invention may be formulated in the form of a composition.

In another embodiment the compositions described herein comprising agrochemically acceptable excipients.

According to an embodiment, at least one agrochemically acceptable excipient comprises wetting agents, dispersing agents, emulsifiers, binding agents, sticking agents, fillers, diluents, solvents, coating agents, stabilizers, chelating agents and coloring agents and buffering agent. However, those skilled in the art will appreciate that it is possible to utilize additional agrochemically acceptable excipients without departing from the scope of the present invention. The agrochemically acceptable excipient can be in the range from 0.1% to 99% of the total weight of the composition.

The amount of a composition according to the invention to be applied, will depend on various factors, such as the subject of the treatment, such as, for example plants, soil or seeds; the type of treatment, such as, for example spraying, dusting or seed dressing; the purpose of the treatment, such as, for example prophylactic or therapeutic disease control; in case of disease control the type of fungi to be controlled or the application time. This amount of the combinations of the present invention to be applied can be readily deduced by a skilled agronomist.

In an embodiment the combination of the present invention maybe formulated as liquid solution.

In an embodiment the combination of the present invention maybe a suspension formulation.

The combination of the present invention maybe formulated in a manner which suits the specific application. The formulation may be solid or liquid formulations. Non-limiting examples of suitable liquid formulations may be emulsion concentrates (EC), suspension concentrates (SC), capsule suspensions (CS); suitable solid formulations may be water dispersible granules (WDG) and wettable powders (WP), dusts and the like.

Adjuvants and ancillary ingredients may be used to formulate such pre-formulated compositions and may employ wetting agents, adhesives, dispersants, penetrants, rain-fastening agents or surfactants and, if appropriate, solvent or oil and other agriculturally acceptable additives and adjuvants.

According to an embodiment of the present invention, a process for the preparation of agrochemical composition comprising a combination of aversive agent and at least one insecticide comprising dissolving mixing active ingredients in to an aqueous solution containing agrochemically acceptable carriers under stirring to form a clear/hazy solution. This solution was stirred continuously till it forms a uniform dispersed. The composition may further comprise at least one selected from anionic surfactant(s), antifreezing agent(s), wetting agent(s), antifoaming agent(s), thickening agents, preservatives, plant health promoting agent and optionally other auxiliary ingredients; and packaging the resulting agrochemical composition.

In an embodiment, the combination of the present invention is preferably effective against the harmful sucking pest.

In another aspect the present invention provides a method for controlling harmful pests in plants, said method comprising applying to the locus of the insect pest infestation, an insecticidal combination comprising an aversive agent and at least one insecticide.

In an embodiment, the present invention provides a method of controlling harmful pests in plants, comprising applying to a locus of the insect pest infestation, an insecticidal combination comprising denatonium compound as aversive agent and at least one insecticide.

According to a still further embodiment, the invention further relates to a method of application of the present agricultural composition comprising said combination of aversive agent and at least one insecticide to crops and plants.

Advantageously, the composition is highly safe to the user and to the environment.

The composition of this invention is effective against a wide spectrum of foliar-feeding, fruit-feeding, stem or root feeding, seed-feeding, aquatic and soil-inhabiting arthropods (term “arthropods” includes insects, mites and nematodes) which are pests of growing and stored agronomic crops, forestry, greenhouse crops, ornamentals, nursery crops, stored food and fiber products, livestock, household, and public and animal health. Those skilled in the art will appreciate that the composition of the present invention is effective against all growth stages of all pests preferably all sucking pest. Nevertheless, the composition of present invention is effective against pests that include: eggs, larvae and adults of the Order Lepidoptera; eggs, foliar-feeding, fruit-feeding, root-feeding, seed-feeding larvae and adults of the Order Coleoptera; eggs, immatures and adults of the Orders Hemiptera and Homoptera; eggs, larvae, nymphs and adults of the Order Acari; eggs, immatures and adults of the Orders Thysanoptera, Orthoptera and Dermaptera; eggs, immatures and adults of the Order Diptera; and eggs, juveniles and adults of the Phylum Nematoda. The compositions of invention are also effective against pests of the Orders Hymenoptera, Isoptera, Siphonaptera, Blattaria, Thysanura and Psocoptera; pests belonging to the Class Arachnida and Phylum Platyhelminthes; southern corn rootworm (Diabrotica undecimpunctata howardi), aster leafhopper (Mascrosteles fascifrons), boll weevil (Anthonomus grandis), two-spotted spider mite (Tetranychus urticae), fall armyworm (Spodoptera frugiperda), black bean aphid (Aphis fabae), green peach aphid (Myzus persica), cotton aphid (Aphis gossypii), Russian wheat aphid (Diuraphis noxia), English grain aphid (Sitobion avenae), whitefly (Bemisia tabacii), tobacco budworm (Heliothis virescens), rice water weevil (Lissorhoptrus oryzophilus), rice leaf beetle (Oulema oryzae), whitebacked planthopper (Sogatella furcifera), green leafhopper (Nephotettix cincticeps), brown planthopper (Nilaparvata lugens), small brown planthopper (Laodelphax striatellus), rice stem borer (Chilo suppressalis), rice leafroller (Cnaphalocrocis medinalis), black rice stink bug (Scotinophara lurida), rice stink bug (Oebalus pugnax), rice bug (Leptocorisa chinensis), slender rice bug (Cletus puntiger), southern green stink bug (Nezara viridula) and german cockroach (Blatella germanica); on mites, demonstrating ovicidal, larvicidal and chemosterilant activity against such families as Tetranychidae including Tetranychus urticae, Tetranychus cinnabarinus, Tetranychus mcdanieli, Tetranychus pacificus, Tetranychus turkestani, Byrobia rubrioculus, Panonychus ulmi, Panonychus citri, Eotetranychus carpini borealis, Eotetranychus, hicoriae, Eotetranychus sexmaculatus, Eotetranychus yumensis, Eotetranychus banksi and Oligonychus pratensis; Tenuipalpidae including Brevipalpus lewisi, Brevipalpus phoenicis, Brevipalpus californicus and Brevipalpus obovatus; Eriophyidae including Phyllocoptruta oleivora, Eriophyes sheldoni, Aculus cornutus, Epitrimerus pyri and Eriophyes mangiferae.

In one embodiment, the combination of the present invention is preferably effective against jassids.

In an embodiment, the Jassid species is selected from Amrasca bigutula bigutula, Adelungiinae; Agalliinae, Aphrodinae, Arrugadinae, Austroagalloidinae Bythoniinae, Cicadellinae, Bothrogonia, Graphocephala (including coccinea), Homalodisca Zyzzogeton, Coelidiinae, Deltocephalinae, Anoplotettix (Ferrari, 1882), Circulifer, Graminella Hecalusina He, Zhang & Webb, 2008, Nephotettix, Stirellus, Drakensbergeninae, Errhomeninae Euacanthellinae, Eupelicinae, Eurymelinae, Eurymela, Eurymeloides, Evacanthinae, Evansiolinae, Hylicinae, Iassinae, Idiocerinae, Idiocerus, Koebeliinae, Ledrinae, Ledra Neotituria, Macropsinae, Oncopsis, Makilingiinae, Megophthalminae, Mileewinae Mukariinae, Neobalinae, Neocoelidiinae, Nioniinae, Nirvaninae, Nirvana, Sophonia Penthimiinae, Phereurhininae, Phlogisinae, Scarinae, Selenocephalinae, Signoretiinae Stegelytrinae, Tartessinae, Tinterominae, Typhlocybinae, Dziwneono, Empoasca, Erasmoneura Young, 1952, Eupteryx, Sweta, Typhlocyba, Ulopinae, Xestocephalinae incertae sedis, Mesojassoides (extinct, late Cretaceous).

In an embodiment, the plants are selected from but not limited to cereals, such as wheat, oats, barley, spelt, triticale, rye, maize, millet, rice, crops such as sugarcane, soybean, sunflower, rape, canola, tobacco, sugar beet, fodder beet; tuber crops such as potatoes, sweet potatoes etc., crops such as asparagus, hops etc.; fruit plants such as apples, pears, stone-fruits such as for example peaches, nectarines, cherries, plums, apricots, citrus fruits such as oranges, grapefruit, limes, lemons, kumquats, mandarins, satsumas; nuts such as pistachios, almonds, walnuts, pecan nuts, tropical fruits such as mango, papaya, pineapple, dates, bananas etc., grapes, vegetables such as endives, lambs, lettuce, fennel, globe and loose-leaf salad, chard, spinach, chicory, cauliflower, broccoli, Chinese cabbage, kale (winter kale or curly kale), kohlrabi, Brussel sprouts, red cabbage, white cabbage and savoy, fruiting vegetables such as aubergines, cucumbers, paprika, marrow, tomatoes, courgettes, sweetcorn, root vegetables such as celeriac, turnip, carrots, swedes, radishes, horse radish, beetroot, salsify, celery, pulses such as peas, beans etc., bulb vegetables such as leeks, onions etc., oil crops such as mustard, poppy, olives, sunflowers, coconut, castor oil plants, cocoa beans, groundnuts; fibre crops such as cotton, jute, flex, hemp, crops such as tea, coffee, rubber, ornamentals including shrubs and flowering plants, vines, rangeland and pastures.

In an embodiment, the method of the present invention may be carried out by applying the combination of aversive agent and at least one insecticide at the locus of the infestation.

Preferably, treating the locus with the combination of the present invention comprises administering to the soil, applying to the plant or parts of the plant or seed with an effective amount of aversive agent and insecticide. The administration is preferably by application either when first signs of infestation are seen or when insect pests begin to reappear.

The combination of aversive agent and insecticides can be obtained from separate formulation sources and mixed together and used as a tank-mix, ready-to-apply, spray broth, or slurry, optionally with other pesticides, or the said combination may be obtained as a single formulation mixture such as a pre-mix, concentrate or formulated product and optionally mixed together with other insecticides, attractants, sterilants, bactericides, acaracides, nematicides, fungicides, growth regulators, herbicides, fertilizers and mixtures thereof.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### EXAMPLES

The following examples are meant to illustrate the present invention. The examples are presented to exemplify the invention and are not to be considered as limiting the scope of the invention.

### Example 1

| Ingredients | Amount in % w/w |
|---|---|
| Denatonium Benzoate | 5 |
| Thiamethoxam | 0.5 |
| Sodium | 2 |
| Lignosulfonate | |
| Polyvinyl Pyridine | 0.5 |
| Water | Q.S. |

### Process:

Above mentioned quantity of polyvinyl Pyridine and Sodium Lignosulfonate were dissolved in water under stirring. Slowly weighed quantity of Denatonium Benzoate and Sodium Lignosulfonate were added to the same mixture under stirring to form a clear/hazy solution. This solution was stirred continuously till it forms a uniform dispersed.

### Example 2

| Ingredients | Quantity in % w/w |
|---|---|
| Denatonium Benzoate | 5 |
| Thiamethoxam | 0.5 |
| alkyl-ether sulfates | 3 |
| Polyvinyl Pyridine | 0.2 |
| Water | Q.S. |

### Process:

Above mentioned quantity of polyvinyl Pyridine and alkyl-ether sulfate were dissolved in water under stirring. Slowly weighed quantity of Denatonium Benzoate and alkyl-ether sulfate were added to the same mixture under stirring to form a clear/hazy solution. This solution was stirred continuously till it forms a uniform dispersed.

### Example 3

| Ingredients | Quantity in % w/w |
|---|---|
| Denatonium Benzoate | 5 |
| Flonicamid | 0.5 |
| Benzalkonium chloride | 4 |
| Polyvinyl Pyridine | 0.4 |
| Water | Q.S. |

### Process:

Above mentioned quantity of polyvinyl Pyridine and Benzalkaonium chloride were dissolved in water under stirring. Slowly weighed quantity of Denatonium Benzoate and Benzalkaonium chloride were added to the same mixture under stirring to form a clear/hazy solution. This solution was stirred continuously till it forms a uniform dispersed.

### Field Trial Data:

### Example 4

Field trials were conducted to study the effect of the combination of Denatonium benzoate with insecticides. The following three combinations were tested on the control of Jassids species Amrasca bigutula bigutula in the crop of infected Okra (Abelmoschus esculentum L) over the use of insecticides alone.
Denatonium benzoate+Flonicamid
Denatonium benzoate+Thiamethoxam
Denatonium benzoate+Imidacloprid

Both phytotoxicity and percentage control of the Jassids was measured. Experimental design of the field trial is given in Table-1 below:

TABLE 1

| Sr. No | Details | Information |
|---|---|---|
| 1 | Experimental Design | RBD |
| 2 | Treatments & Replications: | 9 × 2 |
| 3 | Plot Size | 1.5 × 2 m2 |
| 5 | Crop & Variety | Okra-Sahiba |
| 6 | Soil Type | Black Soil |
| 7 | Irrigation | Drip |
| 8 | Spray Equipment | Back pack Knapsack |
| | | (Electrical) Sprayer |
| 9 | Nozzle | Hollow cone |
| 10 | Water Volume | 500 l/ha |
| 11 | Application Time | @ ETL-2 Jassids per leaf |

Treatment details for the field trial is given in Table-2 below:

TABLE 2

| Treatment | | Dosage of chemicals |
|---|---|---|
| No. | Treatments (T) | (g or ml/lit of water) |
| T-1 | DB Liquid + Ulala | |
| | (Flonicamid 50% WG) | 5 + 0.4 |
| T-2 | DB Liquid + Thiamethoxam | 5 + 0.5 |
| T-3 | DB Liquid + Imidacloprid | 5 + 0.5 |
| T-4 | Ulala | |
| | (Flonicamid 50% WG) | 0.4 |
| T-5 | Thiamethoxam | 0.5 |
| T-6 | Imidacloprid | 0.5 |
| T-7 | DB Liquid | 4 |
| T-8 | DB Liquid | 5 |
| T-9 | Control | — |

T-1, T-2 and T-3 are the treatment with insecticidal combinations according to the present invention; T-4, T-5 and T-6 are the treatment with insecticides alone; T-7 and T-8 are the treatment with Denatonium benzoate (DB) liquid solutions alone and T-9 is the control.

### Phytotoxicity Test Results:

The safety of Denatonium Benzoate (DB) combinations according to present invention on Okra was evaluated. It is observed that the DB combinations according to the present invention are safe and no Phytotoxicity is observed. None of the chemical treatments showed any adverse phytotoxicity symptoms on the plants.

### Synergistic Control of Jassids by the Insecticidal Combinations of Present Invention:

Bio-efficacy of insecticidal combinations of the present invention against Jassids in infected Okra were evaluated. The percentage control of Jassids was measured. Efficacy was evaluated as: Excellent 91-100%, Very good 81-90%, Good 71-80%, Moderate 51-70%, Poor<50%.

Table-3 illustrates the efficacy results of the synergistic combination of present invention.

TABLE 3

| | | | Target | Amrasca bigutula bigutula | | | | | |
|---|---|---|---|---|---|---|---|---|---|
| | | DOSE | Result | % CONTROL | | | | | |
| T.N | TREATMENT | g/ha | A00 | A01 | A03 | A07 | B01 | B03 | B07 |
| T-1 | DB Liquid + | 5 + 0.4 | 5.90 | 81.0 | 92.24 | 94.63 | 93.29 | 93.37 | 95.50 |
| | Ulala | | | | | | | | |
| | (Flonicamid | | | | | | | | |
| | 50% WG) | | | | | | | | |
| T-2 | DB Liquid + | 5 + 0.5 | 7.60 | 72.55 | 85.34 | 84.56 | 78.05 | 83.43 | 86.49 |
| | Thiamethoxam | | | | | | | | |
| T-3 | DB Liquid + | 5 + 0.5 | 7.20 | 73.53 | 77.59 | 73.83 | 76.83 | 77.35 | 79.73 |
| | Imidacloprid | | | | | | | | |
| T-4 | Flonicamid 50% | 0.4 | 6.10 | 78.43 | 90.52 | 91.95 | 91.46 | 92.27 | 93.69 |
| | WG (Ulala) | | | | | | | | |
| T-5 | Thiamethoxam | 0.5 | 6.80 | 70.59 | 83.62 | 81.88 | 77.44 | 80.66 | 80.63 |
| | 25% WG | | | | | | | | |
| T-6 | Imidacloprid | 0.5 | 7.20 | 69.61 | 75.00 | 73.83 | 76.22 | 74.03 | 73.42 |
| | 17.8% SL | | | | | | | | |
| T-7 | DB Liquid | 4 | 7.70 | 5.88 | 8.62 | 4.03 | 7.32 | 7.18 | 5.41 |
| T-8 | DB Liquid | 5 | 8.90 | 8.82 | 10.34 | 9.40 | 10.98 | 10.50 | 10.81 |
| T-9 | Control | — | 9.50 | [10.2*] | [11.6] | [14.9] | [16.4] | [18.1] | [22.2] |

*No. of Jassids per 3 leaf

### Observations:

Selectivity: Good crop safety was observed in both the application rates of Denatonium Benzoate i.e. 4 ml & 5 ml/lit of water on okra.
Efficacy:
Amrasca bigutula bigutula: Jassids
The performance of T-7 DB @ 4 ml/lit of water & T-8 DB @ 5 ml/lit of water are found poor in controlling Okra Jassids.
Treatment T-1 DB+Ulala @ 5+0.4 g/lit of water gives excellent control of Okra Jassids and next best treatments are T-2 DB+Thiamethoxam @ 5+0.5 g/lit of water & T-3 DB+Imidacloprid @ 5+0.4 ml/lit of water.

From the aforesaid, it is observed that all the chemical treatments with the Denatonium Benzoate insecticidal combinations of the present invention were able to effectively reduce the Jassid population and were significantly superior to use of insecticide alone. The combinations were better in reducing the infestation of Jassids as compared to their stand alone treatments. In fact, no significant control of Jassids is observed with using Denatonium Benzoate alone. The combination displayed promising bio-efficacy results in comparison to stand alone treatments.

Denatonium Benzoate (DB) enhances the efficacy of Insecticides and shows Synergy. The efficacy of Flonicamid, Thiamethoxam and Imidacloprid is enhanced after addition of DB. It is found that the present combinations are more effective in killing Jassids (sucking pests) over using insecticides alone. It is clearly observed that Denatonium Benzoate alone does not exhibit any insecticidal activity; however, a combination of Denatonium Benzoate with other insecticides results in a synergistic insecticidal activity.

It is to be understood that the present invention is susceptible to modifications, changes and adaptations by those skilled in the art. Such modifications, changes, adaptations are intended to be within the scope of the present invention.

1. An insecticidal combination comprising aversive agent and at least one insecticide.

2. The combination as claimed in claim 1, wherein said aversive agent is denatonium compound selected from the group consisting of denatonium chloride, denatonium citrate, denatonium saccharide, denatonium carbonate, denatonium acetate, denatonium benzoate, denatonium benzoate monohydrate, and mixtures thereof.

3. The combination as claimed in claim 1, wherein said aversive agent is denatonium benzoate.

4. The combination as claimed in claim 1, where said insecticide is selected from the group consisting of chordotonal organ modulators, nicotinic acetylcholine receptor (nAChR) competitive modulators, acetylcholinesterase (AChE) inhibitors, GABA-gated chloride channel blockers, sodium channel modulators, nicotinic acetylcholine receptor (nAChR) allosteric modulators—Site I, glutamate-gated chloride channel (GluCl) allosteric modulators, juvenile hormone mimics, miscellaneous nonspecific (multi-site) inhibitors, chordotonal organ TRPV channel modulators, mite growth inhibitors affecting CHS1, microbial disruptors of insect midgut membranes, inhibitors of mitochondrial ATP synthase, uncouplers of oxidative phosphorylation via disruption of the proton gradient, nicotinic acetylcholine receptor (nAChR) channel blockers, inhibitors of chitin biosynthesis affecting CHS1, inhibitors of chitin biosynthesis type 1, moulting disruptors, dipteran, ecdysone receptor agonists, octopamine receptor agonists, mitochondrial complex III electron transport inhibitors, mitochondrial complex I electron transport inhibitors, voltage-dependent sodium channel blockers, inhibitors of acetyl CoA carboxylase, mitochondrial complex IV electron transport inhibitors, mitochondrial complex II electron transport inhibitors, ryanodine receptor modulators, GABA-gated chloride channel allosteric modulators and unknown mode of action compounds, and combinations thereof.

5. A composition comprising a combination of an aversive agent, at least one insecticide, and an agrochemically acceptable excipient.

6. The composition as claimed in claim 5, wherein said aversive agent is present in an amount in the range of 0.01 to 50% w/w based on the total weight of the composition.

7. The composition as claimed in claim 5, wherein said insecticide is present in an amount in the range of 0.1 to 99% w/w based on the total weight of the composition.

8. The composition as claimed in claim 5, wherein said aversive agent is denatonium benzoate and said insecticide is selected from chordotonal organ modulator insecticides and neonicotinoid insecticides.

9. The composition as claimed in claim 5, comprising denatomium benzoate and flonicamid, imidacloprid, thiamethoxam or a combination thereof.

10. A method of controlling harmful pests in plants, comprising applying to a locus of the insect pest infestation, an insecticidal combination comprising a denatonium compound as an aversive agent and at least one insecticide.
